(19) United States
(12) Patent Application Publication
(10) Pub. No.: US 2015/0066449 A1
(43) Pub. Date: Mar. 5, 2015

(54) SOLAR FARM AND METHOD FOR FORECASTING SOLAR FARM PERFORMANCE

(71) Applicant: General Electric Company, Schenectady, NY (US)

(72) Inventors: Sameer Vittal, Marietta, GA (US); Mark Ronald Lynass, Munich (DE); Romano Patrick, Marietta, GA (US); David Nuelle, Portland, OR (US); Bruce Gordon Norman, Burnt Hills, NY (US)

(73) Assignee: General Electric Company, Schenectady, NY (US)

(21) Appl. No.: 14/013,121

(22) Filed: Aug. 29, 2013

(51) Int. Cl. G06F 17/50

(52) U.S. Cl. CPC G06F 17/5009
USPC 703/2

(57) ABSTRACT

Solar farms and methods for forecasting solar farm performance are provided. A method may include, for example, the steps of analyzing in a computing device at least one historic or estimated usage parameter and at least one design limit parameter, and determining an estimated failure probability for at least one solar module of the solar farm based on the at least one historic or estimated usage parameter and at least one design limit parameter. A method may further include, for example, the steps of receiving in the computing device at least one real time usage parameter, and calculating an updated failure probability based on the estimated failure probability and the least one real time usage parameter.

### FIELD OF THE INVENTION

The present disclosure relates generally to solar farms, and more particularly to methods and apparatus for forecasting solar farm performance.

### BACKGROUND OF THE INVENTION

In recent decades there has been a move towards the use of renewable resources to generate energy. In particular, solar energy-based systems have begun to increase in performance and popularity. One trend in solar energy is to install one or more solar modules together to constitute a solar farm. Each module may include, for example, one or more photovoltaic panels and one or more inverters and/or other power transmission apparatus. The modules are typically interconnected to form the solar farm, and energy generated in the farm is transmitted to load points or a power grid via suitable transmission lines.

One issue in the construction and use of a solar farm is the ability to calculate the risks inherent in the solar farm due to, for example, failure of various components of the farm during operation and over time. The lack of ability to accurately forecast these risks can result in a solar farm becoming a significant liability. Conversely, the ability to accurately forecast these risks would lessen the chance of a solar farm becoming a liability, and allow the efficiency and operability of the solar farm to be increased. More specifically, inspection and replacement schedules could be more accurately produced and followed, and potential emergency issues could be identified and addressed before-the-fact.

However, presently known attempts to forecast solar farm performance have been sporadic and relatively inaccurate. For example, classical reliability techniques, such as failure rate analysis and system reliability models, have been utilized, but increases in the accuracy of presently known techniques are desired.

Accordingly, solar farms and methods for forecasting solar farm performance are desired in the art. In particular, solar farms and forecasting methods that utilize both historical and real time data, and that provide improved performance forecasting, would be advantageous.

### BRIEF DESCRIPTION OF THE INVENTION

Aspects and advantages of the invention will be set forth in part in the following description, or may be obvious from the description, or may be learned through practice of the invention.

In one embodiment, the present disclosure is directed to a method for forecasting solar farm performance. The method includes the steps of analyzing in a computing device at least one historic or estimated usage parameter and at least one design limit parameter, and determining an estimated failure probability for at least one solar module of the solar farm based on the at least one historic or estimated usage parameter and at least one design limit parameter. The method further includes the steps of receiving in the computing device at least one real time usage parameter, and calculating an updated failure probability based on the estimated failure probability and the least one real time usage parameter.

In another embodiment, the present disclosure is directed to a method for forecasting solar farm performance. The method includes the steps of analyzing in a computing device at least one historic or estimated usage parameter and at least one design limit parameter, and determining an estimated failure probability for at least one solar module of the solar farm based on the at least one historic or estimated usage parameter and at least one design limit parameter and utilizing one of a univariate Weibull model or a bivariate Weibull model such that the estimated failure probability is estimated per at least one of time or usage of the at least one solar module. The method further includes the steps of receiving in the computing device at least one real time usage parameter, and calculating through utilization of a Bayesian estimation algorithm an updated failure probability based on the estimated failure probability and the least one real time usage parameter.

In another embodiment, the present disclosure is directed to a solar farm. The solar farm includes at least one solar module, the at least one solar module comprising a panel and an inverter. The solar farm further includes a computing device in communication with the at least one solar module. The computing device is operable to analyze at least one historic or estimated usage parameter and at least one design limit parameter, determine an estimated failure probability for the least one solar module based on the at least one historic or estimated usage parameter and at least one design limit parameter, receive at least one real time usage parameter, and calculate an updated failure probability based on the estimated failure probability and the least one real time usage parameter.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic illustration of a solar farm according to one embodiment of the present disclosure;

FIG. 2 is a schematic illustration of a controller according to one embodiment of the present disclosure; and

FIG. 3 is a flow chart illustrating a method according to one embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

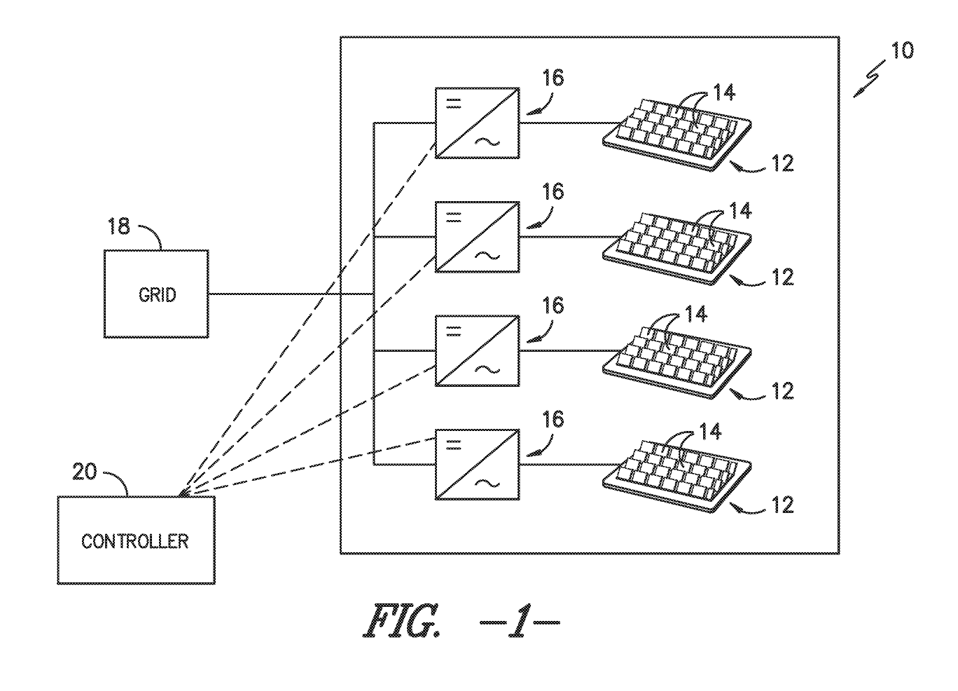

FIG. 1 illustrates one embodiment of a solar farm 10 according to the present disclosure. The solar farm 10 may include, for example, one or more solar modules 12. A module 12 may include one or more panels 14, also known for example as photovoltaic cells. A module 12 may further include a plurality of inverters 16. Solar farm 10 thus generally includes one or more panels 14 one or more inverters 16, which in the case of more than one panels 14 and/or inverters 16 may be split into multiple modules 12. Power generated in/by the panels 14 may be transmitted through the inverters 16 to the power grid 18, as is generally understood.

It should be understood that the present disclosure is not limited to any particular solar module 12, or panel 14 or inverter 16 thereof. For example, while in some embodiments cadmium telluride (CdTe) panels 14 may be utilized, any suitable panels 14 are within the scope and spirit of the present disclosure.

As further illustrated in FIG. 1, a controller 20 may be included in the solar farm 10 and in communication with the modules 12. The controller 20 may control operation of the modules 12, and may further receive, analyze, and process information from the modules 12 and the solar farm 10 in general.

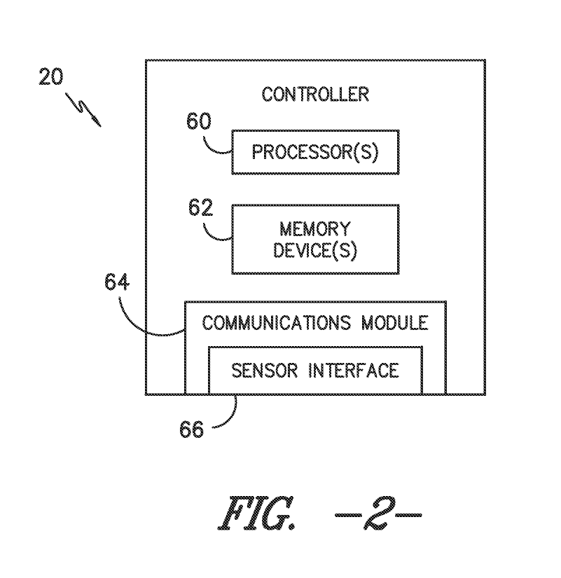

It should be appreciated that the controller 20 may generally comprise a computing device, such as a computer or any other suitable processing unit. Thus, in several embodiments, the controller 20 may include one or more processor(s) and associated memory device(s) configured to perform a variety of computer-implemented functions, as shown in FIG. 2 and discussed herein. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) of the controller 20 may generally comprise memory element(s) including, but are not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) may generally be configured to store suitable computer-readable instructions that, when implemented by the processor(s), configure the controller 20 to perform various computer-implemented functions including, but not limited to, performing proportional integral derivative (“PID”) control algorithms, including various calculations within one or more PID control loops, and various other suitable computer-implemented functions, such as those discussed herein. In addition, the controller 20 may also include various input/output channels for receiving inputs from sensors and/or other measurement devices and for sending control signals to various other components of the solar farm 10.

Referring now to FIG. 2, there is illustrated a block diagram of one embodiment of suitable components that may be included within the controller 20 in accordance with aspects of the present subject matter. As shown, the controller 20 may include one or more processor(s) 60 and associated memory device(s) 62 configured to perform a variety of computer-implemented functions (e.g., performing the methods, steps, calculations and the like disclosed herein). Additionally, the controller 20 may also include a communications module 64 to facilitate communications between the controller 20 and the various other components of the solar farm 10. Moreover, the communications module 64 may include a sensor interface 66 (e.g., one or more analog-to-digital converters) to permit input signals transmitted from, for example, various sensor, to be converted into signals that can be understood and processed by the processors 60.

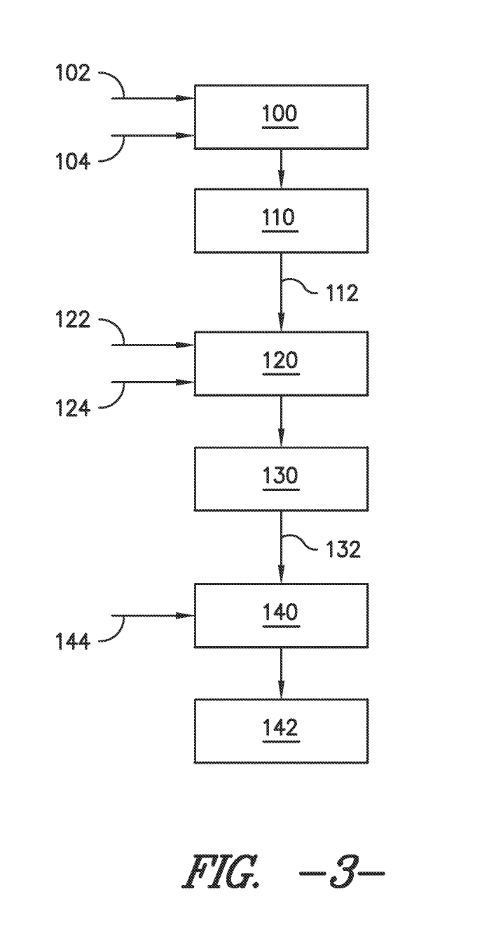

Referring now to FIG. 3, the present disclosure is further directed to methods for forecasting solar farm 10 performance Methods according to the present disclosure advantageously utilize both estimated and historical usage parameters as well as real time usage parameters for the solar farm to provide failure probabilities for the solar farm 10 and various components thereof Through use of such present methods, the accuracy of the failure probabilities that are generated is advantageously increased. Further, such failure probabilities can advantageously be utilized to improve various solar farm 10 operations plans and schedules, such as inspection schedules, replacement schedules, and unplanned outage plans. Additionally, such failure probabilities can advantageously be utilized to generate improved business plans, system recommendations, and cost estimates.

A method according to the present disclosure may include, for example, the step 100 of analyzing in a controller 20, such as in exemplary embodiments a computing device, one or more historic or estimated usage parameters 102 and one or more design limit parameters 104. A usage parameter, such as a historic or estimate usage parameter 102 or a real time usage parameter as discussed below, may generally be a characteristic of the solar farm 10 or a component thereof, such as a panel 14, inverter 16 and/or balance of equipment in a module 12, that may impact the performance of the solar farm 10 or component. For example, suitable usage parameters include solar radiation measurement, cloud factor, clear sky index, humidity measurement, soiling loss factor, and temperature measurement for the solar farm 10, such as for the solar farm 10 generally or for a specific component or components thereof According to the present method step 100, historic or estimated usage parameters 102 may be input into the controller 20 and analyzed by the controller 20. A historic usage parameter 102 includes historic data for a particular usage parameter, such as for previously occurring time periords. An estimated usage parameter 102 includes data that is estimated for a particular usage parameter, if for example historical data is not available. For example, various historic data points may be utilized to generate an estimated trend in a particular usage parameter, or another suitable method may be utilized to estimate a usage parameter 102. Generally estimated usage parameters 102 are estimated for previously occurring time periods.

A design limit parameter 104 is generally an equation which provides a limit for performance of the solar farm 10, such as a component thereof Such equations are generally physics-based equations that provide limits which, if exceeded, result in failure of the equation. In particular, suitable transfer functions may be utilized. Transfer functions are typically polynomial response surfaces of the type shown in the equation below, where the model is derived from running a large number of physics-based simulations. For example, one suitable example of a transfer function is:

$$y = {b}_{0} + {\sum }_{i = 1}^{n} {b}_{i} {x}_{i} + {\sum }_{i < j} \sum {b}_{ik} {x}_{i} {x}_{j} + ɛ$$

wherein y is an engineering output (energy output, mechanical life, etc.); b[0], b[1], b[1,2], etc. are the response surface coefficients, and ε is an estimate of normally distributed model error. Design limit parameters 104 may be provided for the solar farm 10 in general and/or for specific components thereof, such as the panels 14, inverters 16, and/or the balance of equipment in a module 12. According to the present method step 100, design limit parameters 104 may be input into the controller 20 and analyzed by the controller 20.

A method according to the present disclosure may include, for example, the step 110 of determining an estimated failure probability 112 for the solar farm 10, such as for one or more modules 12 of the solar farm, based on the historic or estimated usage parameters 102 and the design limit parameters 104. Generally, such determination is performed in the controller 20 using suitable models, simulations, methods and/or algorithms. For example, in some embodiments, a univariate Weibull model may be utilized to perform such determination. One embodiment of a typical univariate Weibull model is demonstrated as follows:

$$F ( t ) = 1 - exp [ - {( \frac{t}{η} )}^{β} ]$$

wherein t is time, β is a shape parameter and η is a scale parameter. Alternatively, the variable u can be substituted for the variable t. The variable u is usage. Usage is generally provided as a usage index for the module(s) 12 or solar farm 10 in general, and indicates the severity of use of the module(s) 12 or solar farm 10 and components thereof. A usage index can be fixed or generated per time. In these embodiments, a method may thus include utilizing a univariate Weibull model such that the estimated failure probability 112 is estimated per one of time or usage of one or more solar modules 12. Accordingly, a univariate Weibull model may be programmed into the controller 20, such that this model is utilized in generation of the estimated failure probability 112 based on the historic or estimated usage parameters 102 and the design limit parameters 104.

In other embodiments, a bivariate Weibull model may be utilized to perform such determination. One embodiment of a bivariate Weibull model is demonstrated as follows:

$$F ( t , u ) = 1 - exp [ - {( {( \frac{t}{{η}_{t}} )}^{{β}_{t}} + {( \frac{U}{{η}_{U}} )}^{{β}_{U}} )}^{δ} ]$$

Wherein t is time, u is usage, β[t] and β[t] are shape parameters for time and usage respectively, η[t] and η[t] are location parameters of time and usage respectively, and δ is a parameter analogous to the correlation between time and usage. In these embodiments, a method may thus include utilizing a bivariate Weibull model such that the estimated failure probability 112 is estimated per time and usage of one or more solar modules 12. Accordingly, a bivariate Weibull model may be programmed into the controller 20, such that this model is utilized in generation of the estimated failure probability 112 based on the historic or estimated usage parameters 102 and the design limit parameters 104.

As discussed, β, η, and δ are parameters utilized in models such as univariate and bivariate Weibull models. These parameters may be generated through the use of various methods and/or simulations performed in the controller 20 during determination of the estimated failure probability 112. For example, in some embodiments, a Monte Carlo simulation may be utilized to output the estimated failure probability 112 based on the historic or estimated usage parameters 102 and the design limit parameters 104. In other embodiments, a first order reliability method or a second order reliability method may be utilized to output the estimated failure probability 112 based on the historic or estimated usage parameters 102 and the design limit parameters 104. Accordingly, such simulation or method may be programmed into the controller 20, such that the controller provides the determination of estimated failure probability 112 by inputting the historic or estimated usage parameters 102 and the design limit parameters 104 into such simulation or method. Further, as discussed, after inputting the parameters 102, 104 into such simulation or methods, the simulation or method may be programmed to output estimates for various parameters, such as β, η, and δ as discussed above. These parameters may then be utilized in, for example, a univariate or bivariate Weibull model to output the estimated failure probability 112 for the solar farm 10 or a module 12 or component thereof as either a function of time or usage or as a function of time and usage, as discussed above.

A method according to the present disclosure may include, for example, the step 120 of receiving in the controller 20 one or more real time usage parameter 122. Real time usage parameters are measurements of usage parameters, as discussed above, in real time as they are occurring. The usage parameters for which real time data is obtained are, in exemplary embodiments, the same usage parameters for which historic or estimated data is provided, as discussed above. Such real time usage parameters 122 may be obtained through suitable sensors on the solar farm 10 and/or modules 12 or components thereof.

In some exemplary embodiments, the receiving step 120 may further include, for example, receiving time-based data which corresponds to the real time usage parameters 122. For example, the receiving step 120 may include receiving a real time operation count 124 into the controller 20. The real time operation count 124 may be a record of the operating time of the solar farm 10 and/or modules 12 or components thereof. Such operating time may correspond to the real time usage parameters 122, such that the times of occurrences of various measurements of real time usage parameters 122 are known.

A method according to the present disclosure may further include, for example the step 130 of calculating an updated failure probability 132 based on the estimated failure probability 112 and the real time usage parameters 122. Generally, such calculation is performed in the controller 20 using suitable models, simulations, methods and/or algorithms. For example, in some embodiments, a Bayesian estimation algorithm may be utilized to perform such calculation. One embodiment of a Bayesian estimation algorithm is demonstrated as follows:

$$f ( {β}_{U} , {β}_{t} , {η}_{U} , {η}_{t} , δ \vert data ) = \frac{L ( data \vert {β}_{U} , {β}_{t} , {η}_{U} , {η}_{t} , δ ) \cdot f ( {β}_{U} , {β}_{t} , {η}_{U} , {η}_{t} , δ )}{\int L ( data \vert {β}_{U} , {β}_{t} , {η}_{U} , {η}_{t} , δ ) \cdot d F ( {β}_{U} , {β}_{t} , {η}_{U} , {η}_{t} , δ )}$$

wherein f (β_{U}, βₜ, η_{U}, ηₜ, δ|data) is the Bayesian “posterior” probability density as a function of the parameters of the bivariate Weibull model (determined for example via Monte-Carlo simulation methods commonly used for Bayesian estimation (E.g. Gibbs sampling)); L(data|β_{U}, βₜ, η_{U}, ηₜ, δ) is the statistical likelihood of the bivariate Weibull given the available monitored data; and f(β_{U}, βₜ, η_{U}, ηₜ, δ) is the “a priori” distribution of the bivariate Weibull parameters, usually a 5-dimensional joint multivariate normal distribution.

In these embodiments, a method may thus include utilizing a Bayesian estimation algorithm to output the updated failure probability 132 based on the estimated failure probability 112 and the real time usage parameters 122. Accordingly, a Bayesian estimation algorithm may be programmed into the controller 20, such that this algorithm is utilized in generation of the updated failure probability 132 based on the estimated failure probability 112 and the real time usage parameters 122.

A method according to the present disclosure may further include, for example, the step 140 of providing a performance forecast 142 for the solar farm 10, such as for one or more modules 12 thereof. The performance forecast 142 may include the updated failure probability 132, as discussed above, and a cost schedule 144 for the solar farm 10, such as for the one or more modules 12 thereof. The cost schedule 144 may include, for example, pricing information on the solar farm 10 and/or modules 12 or components thereof. Further, in some embodiments, depreciation estimates or other suitable valuation estimates may be included with the pricing information in the cost schedule 144. Such cost schedule and updated failure probability 132 may be provided together as a performance forecast 142. As discussed above, the updated failure probability 132, as well as the performance forecast 142, may provide improved accuracy with respect to solar farm forecasting. Further, such outputs may be utilized to improve various solar farm 10 operations plans and schedules, such as inspection schedules, replacement schedules, and unplanned outage plans. Additionally, such outputs can advantageously be utilized to generate improved business plans, system recommendations, and cost estimates. Thus, methods according to the present disclosure, as well as solar farms 10 which include controllers 20 capable of performing such methods, advantageously provide improved solar farm 10 performance forecasting.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for forecasting solar farm performance, the method comprising:
analyzing in a computing device at least one historic or estimated usage parameter and at least one design limit parameter;
determining an estimated failure probability for at least one solar module of the solar farm based on the at least one historic or estimated usage parameter and at least one design limit parameter;
receiving in the computing device at least one real time usage parameter; and
calculating an updated failure probability based on the estimated failure probability and the least one real time usage parameter.

2. The method of claim 1, wherein the at least one usage parameter is one of a solar radiation measurement, a cloud factor, a clear sky index, a humidity measurement, a soiling loss factor, or a temperature measurement for the solar farm.

3. The method of claim 1, wherein the determining step comprises utilizing a univariate Weibull model such that the estimated failure probability is estimated per one of time or usage of the at least one solar module.

4. The method of claim 1, wherein the determining step comprises utilizing a bivariate Weibull model such that the estimated failure probability is estimated per time and usage of the at least one solar module.

5. The method of claim 1, wherein the determining step comprises utilizing a Monte Carlo simulation to output the estimated failure probability based on the at least one historic or estimated usage parameter and the at least one design limit parameter.

6. The method of claim 1, wherein the determining step comprises utilizing one of a first order reliability method or a second order reliability method to output the estimated failure probability based on the at least one historic or estimated usage parameter and the at least one design limit parameter.

7. The method of claim 1, wherein the at least one solar module comprises a panel and an inverter, and wherein the at least one design limit parameter is one of a panel design limit parameter or an inverter design limit parameter.

8. The method of claim 1, wherein the at least one design limit parameter is a transfer function.

9. The method of claim 1, wherein the calculating step comprises utilizing a Bayesian estimation algorithm to output the updated failure probability based on the estimated failure probability and the at least one real time usage parameter.

10. The method of claim 1, wherein the receiving step further comprises receiving a real time operation count into the computing device.

11. The method of claim 1, further comprising providing a performance forecast for the at least one solar module, the performance forecast comprising the updated failure probability and a cost schedule for the at least one solar module.

12. A method for forecasting solar farm performance, the method comprising:
analyzing in a computing device at least one historic or estimated usage parameter and at least one design limit parameter;
determining an estimated failure probability for at least one solar module of the solar farm based on the at least one historic or estimated usage parameter and at least one design limit parameter and utilizing one of a univariate Weibull model or a bivariate Weibull model such that the estimated failure probability is estimated per at least one of time or usage of the at least one solar module;
receiving in the computing device at least one real time usage parameter; and
calculating through utilization of a Bayesian estimation algorithm an updated failure probability based on the estimated failure probability and the least one real time usage parameter.

13. The method of claim 12, wherein the at least one usage parameter is one of a solar radiation measurement, a cloud factor, a clear sky index, a humidity measurement, a soiling loss factor, or a temperature measurement for the solar farm.

14. The method of claim 12, wherein the determining step comprises utilizing one of a Monte Carlo simulation, a first order reliability method or a second order reliability method to output the estimated failure probability based on the at least one historic or estimated usage parameter and the at least one design limit parameter.

15. A solar farm, the solar farm comprising:
at least one solar module, the at least one solar module comprising a panel and an inverter; and
a computing device in communication with the at least one solar module, the computing device operable to analyze at least one historic or estimated usage parameter and at least one design limit parameter, determine an estimated failure probability for the least one solar module based on the at least one historic or estimated usage parameter and at least one design limit parameter, receive at least one real time usage parameter, and calculate an updated failure probability based on the estimated failure probability and the least one real time usage parameter.

16. The solar farm of claim 15, wherein the at least one usage parameter is one of a solar radiation measurement, a cloud factor, a clear sky index, a humidity measurement, a soiling loss factor, or a temperature measurement for the solar farm.

17. The solar farm of claim 15, wherein the controller utilizes a univariate Weibull model such that the estimated failure probability is estimated per one of time or usage of the at least one solar module.

18. The solar farm of claim 15, wherein the controller utilizes a bivariate Weibull model such that the estimated failure probability is estimated per time and usage of the at least one solar module.

19. The solar farm of claim 15, wherein the controller utilizes one of a Monte Carlo simulation, a first order reliability method or a second order reliability method to output the estimated failure probability based on the at least one historic or estimated usage parameter and the at least one design limit parameter

20. The solar farm of claim 15, wherein the controller utilizes a Bayesian estimation algorithm to output the updated failure probability based on the estimated failure probability and the at least one real time usage parameter.
